(19) United States
(12) Patent Application Publication
(10) Pub. No.: US 2022/0381625 A1
(43) Pub. Date: Dec. 1, 2022

(54) TEMPERATURE MEASUREMENT METHOD BASED ON THE FLUORESCENCE CHARACTERISTIC OF OPTICAL MATERIAL AND TEMPERATURE SENSOR USING THE SAME

(71) Applicant: GIST(Gwangju Institute of Science and Technology), Gwangju (KR)

(72) Inventor: Bok Hyeon KIM, Gwangju (KR)

(73) Assignee: GIST(Gwangju Institute of Science and Technology), Gwangju (KR)

(21) Appl. No.: 17/749,465

(22) Filed: May 20, 2022

(30) Foreign Application Priority Data
May 21, 2021 (KR) 10-2021-0065262
Nov. 25, 2021 (KR) 10-2021-0164925

(51) Int. Cl. G01K 11/20

(52) U.S. Cl. CPC G01K 11/20

(57) ABSTRACT

Disclosed are a temperature measurement method using the fluorescence characteristic of an optical material having temperature dependence and a temperature sensor technology using the same. According to the present disclosure, the temperature measurement technology using the fluorescence signal intensity ratio has a self-compensation function to reduce optical signal noise caused by fluctuations in light source output and optical waveguide loss, and uses two fluorescence signals with a strong fluorescence signal intensity to solve the existing disadvantage of generating a lot of noise due to a low fluorescence signal.

### CROSS-REFERENCE TO RELATED APPLICATIONS

This application claims the priority of Korean Patent Application No. 10-2021-0065262 filed on May 21, 2021 and Korean Patent Application No. 10-2021-0164925 filed on Nov. 25, 2021, in the Korean Intellectual Property Office, the disclosure of which is incorporated herein by reference.

### BACKGROUND OF THE INVENTION

### Field of the Invention

The present disclosure relates to a temperature measurement method using the fluorescence characteristic of an optical material having temperature dependence and a temperature sensor technology using the same.

### Description of the Related Art

Among various measurement sensors, a temperature sensor plays a very important role in the state analysis and safety monitoring of major facilities and devices in the fields of electric power systems, construction, chemical industry, aerospace, defense, and medical industries.

Due to the characteristic of the modern industrial society showing high electric power dependence, accidents occurring in important electric power systems may cause massive economic damage such as large-scale blackouts of tens of thousands of households or more and the disruption of important industrial facilities and this can cause great social chaos.

The number of operations of important power devices such as transformers, switches, and panel boards is continuously increasing, and the number of aging devices is also increasing accordingly. In addition, overheating and fire accidents frequently happen due to the occurrence of overload caused by a rapid increase in electricity consumption, the absence of an accurate measurement system, and the like.

There are various causes of failure of power facilities, but in the end, most of the failures result in fires or explosions due to overheating. Therefore, it is very important to secure a technology that can prevent accidents in advance by monitoring the overheating state through real-time temperature measurement.

In the case of the existing temperature measurement technology applied to high voltage transformers, an electric method using the temperature-dependent characteristics of metal or semiconductor materials, a bimetal method using the thermal expansion characteristics of metal materials, and a bourdon method using the thermal expansion characteristics of metal tubes have been used. Therefore, in the case of the existing technology, since a metal material or a housing is used, there is a problem that the temperature of a hot spot where a high voltage is applied cannot be directly measured due to an insulation problem.

In the case of the existing technology for the high-voltage transformers, the temperature cannot be directly measured by mounting a temperature sensor on a winding unit, but there is used a method of indirectly calculating the temperature of the winding unit by simulation from a temperature measured at insulating oil or bushings. Accordingly, there is a problem in that the accuracy or speed of measurement is deteriorated.

In order to solve these problem of electrical or mechanical (bimetal, Bourdon) temperature measurement method, optical temperature measurement technology can be applied. In the case of an optical temperature sensor technology, since a core material of the sensor such as glass optical fiber is formed of an optical material with an electrical insulation property, it is possible to directly measure the temperature by mounting a temperature sensor probe on a high-temperature hot spot region, unlike electrical or mechanical temperature sensors.

In addition, in the case of the optical temperature sensor technology, since light is used as a means of temperature measurement, an electromagnetic interference problem does not occur, and there is an advantage of facilitating remote measurement by using an optical fiber guide technology.

In an optical temperature measurement method that does not have the problems of the electrical or mechanical temperature sensor, a method using the fluorescence characteristic of an optical material having temperature dependence may be used. The method using the fluorescence characteristics may be divided into a method using temperature dependence of a fluorescence lifetime and a method using temperature dependence of a fluorescence intensity.

In the case of the method using the temperature dependence of a fluorescence decay lifetime, it is necessary to accurately measure the decay time from a fluorescence decay curve. To this end, expensive high-speed photo detector and signal processing module are required, and a method of fitting a fluorescence decay curve is used to measure the decay time, but it is very difficult to secure the accuracy and speed of fitting.

As another method, there is a method of using an intensity ratio of fluorescence signals generated from two thermally coupled energy levels according to a Boltzmann distribution. Since the relative intensity of the fluorescence signal generated at the thermally coupled energy level follows the Boltzmann distribution to have temperature dependence. By using this, it is possible to derive the temperature inversely by measuring the intensity ratio of the fluorescence signal, and to reduce the complexity and error of the system that occur in the method using the temperature dependence of the fluorescence decay lifetime.

In the case of the optical temperature measurement method, a temperature measurement range, temperature measurement stability, noise characteristics, and the like are greatly affected by an optical characteristics analysis method selected according to an operating principle of optical characteristics used for temperature measurement, optical spectral characteristics of optical materials, a measurement principle, and optical spectral characteristics of optical materials. In particular, in the case of a temperature measurement method using the fluorescence characteristics, it is very important to appropriately select a type of fluorescence material, a wavelength position of a pump wavelength, and a wavelength position of a fluorescence signal used for measurement.

The above-described technical configuration is the background art for helping in the understanding of the present invention, and does not mean a conventional technology widely known in the art to which the present invention pertains.

### SUMMARY OF THE INVENTION

The present disclosure is to solve various problems of the related art, and an object of the present disclosure is to provide a method of measuring a temperature using the fluorescence characteristic of an optical material having a temperature-dependent characteristic.

Objects of the present disclosure are not limited to the objects described above, and other objects, which are not mentioned above, will be apparent from the following description.

According to an aspect of the present disclosure, there is provided a temperature measurement method using an intensity ratio of fluorescence signals by using an intensity ratio of fluorescence signals generated according to an energy level difference of rare earth ions excited by pump light.

The intensity ratio of the fluorescence signals may be an intensity ratio of a pair of fluorescence signals generated according to a difference between different energy levels of rare earth ions.

The wavelength of the fluorescence signal may be 60 nm or more spaced apart from the wavelength of the pump light.

The pair of fluorescence signals may be generated by an energy transition from one high energy level to two low energy levels.

The rare earth ions may be Nd³⁺ ions, the high energy level may be 4F_{3/2}, and the low energy level may be two energy levels selected from the group consisting of 4I_{9/2}, 4I_{11/2} and 4I_{13/2}.

The pair of fluorescence signals may be generated by an energy transition from two different high energy levels from each other to a low energy level or low energy levels.

The intensity ratio of the fluorescence signal may be an intensity ratio between a first fluorescence signal by an energy transition of 4F_{5/2}→4I_{11/2} of Nd³⁺ ions and a second fluorescence signal generated by the other energy transition.

The second fluorescence signal may be a fluorescence signal generated by an energy transition of 4F_{3/2}→4I_{9/2} or 4F_{3/2}, →4I_{11/2} of Nd³⁺ ions.

An intensity graph of the fluorescence signal may be fitted to any one or more functions of a polynomial function, an exponential function, and a logarithmic function. According to another aspect of the present disclosure, there is provided a temperature sensor system using an intensity ratio of fluorescence signals generated according to an energy level difference of rare earth ions.

The temperature sensor system may include a temperature sensor probe provided with an optical material containing rare earth ions at one end; and an optical fiber guide equipped to the other end of the temperature sensor probe.

The temperature sensor system may further include a pump source for forming a light source exciting the rare earth ions through the optical fiber guide; a photo detector for measuring a fluorescence signal generated from the optical material through the optical fiber guide; and an analyzer for analyzing the fluorescence signal received through the photo detector.

According to an embodiment of the present disclosure, since the temperature measurement technology according to the present disclosure measures the temperature by using an optical material having insulation property, it is possible to directly measure the temperature by mounting a temperature sensor probe on the hot spot region, unlike electrical or mechanical temperature sensors.

In addition, in the case of the temperature measurement technique according to the present disclosure, since light is used as a means of temperature measurement, an electromagnetic interference problem does not occur. In addition, there is an advantage of facilitating remote measurement by using an optical fiber guide technology.

In addition, the temperature measurement technology using the fluorescence signal intensity ratio according to the present disclosure has a self-compensation function to reduce optical signal noise caused by fluctuations in light source output and optical waveguide loss, and uses two fluorescence signals with a strong fluorescence signal intensity to solve the existing disadvantage of generating a lot of noise due to low fluorescence signal. Therefore, the accuracy of the temperature signal calculated therefrom also does not deteriorate.

In addition, since the temperature measurement technology according to the present disclosure uses Nd³⁺ ions as an example, there are advantages of having excellent fluorescence efficiency, easy temperature measurement, and excellent temperature measurement sensitivity.

In addition, the temperature measurement technology according to the present disclosure can reduce the size and cost of the temperature sensor.

In addition, the optical temperature sensor according to the present disclosure maybe applied to the state analysis and safety monitoring of major facilities and devices in the fields of power systems, construction, chemical industry, aerospace, defense, and medical industries. In particular, the optical temperature sensor according to the present disclosure may be applied to high-voltage power systems, such as transformers and switches that require direct temperature measurement of the temperature of a hot spot.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and other advantages of the present invention will be more clearly understood from the following detailed description taken in conjunction with the accompanying drawings, in which:

FIG. 1 is a diagram illustrating a temperature calculation method through transition between energy levels of Nd³⁺ ions and fluorescence intensity ratio analysis using the same according to the related art;

FIG. 2A is a diagram illustrating a temperature calculation method through transition from an energy level 4F_{3/2} to other levels of Nd³⁺ ions and fluorescence intensity ratio analysis using the same according to an embodiment of the present disclosure;

FIG. 2B is a diagram illustrating a temperature calculation method through fluorescence intensity ratio analysis using an energy transition of 4F_{5/2}→4I_{11/2} of Nd³⁺ ions according to an embodiment of the present disclosure;

FIG. 3 is a diagram illustrating fluorescence spectral characteristics (wavelength of pump light: 795 nm) with respect to the temperature in an oxide-based optical glass containing Nd³⁺ ions according to an embodiment of the present disclosure;

FIG. 4 is a diagram illustrating change characteristics in a fluorescence intensity ratio with respect to the temperature of an optical material containing Nd³⁺ ions according to an embodiment of the present disclosure;

FIG. 5A is a diagram illustrating a temperature calculation characteristic result using a fluorescence intensity ratio analysis method according to the related art;

FIG. 5B is a diagram illustrating a temperature calculation characteristic result using a fluorescence intensity ratio analysis method according to an embodiment of the present disclosure;

FIG. 6A is a diagram illustrating an overall structure of the temperature sensor probe according to an embodiment of the present disclosure;

FIG. 6B is a diagram illustrating a process of generating and transmitting fluorescence signals at a tip portion of a temperature sensor probe to which a temperature measurement method using a fluorescence intensity ratio according to an embodiment of the present disclosure is applied; and

FIG. 7 is a diagram illustrating a structure of a temperature sensor system to which the temperature measurement method using the fluorescence intensity ratio according to an embodiment of the present disclosure is applied.

### DETAILED DESCRIPTION OF THE PREFERRED EMBODIMENT

The present disclosure may have various modifications and various embodiments and specific embodiments will be illustrated in the drawings and described in detail.

Various features of the invention disclosed in the appended claims will be better understood in consideration of the drawings and the detailed description. Apparatuses, methods, manufacturing methods and various embodiments disclosed in the specification will be provided for illustrative purposes. The disclosed structural and functional features are intended to allow those skilled in the art to be specifically implemented in various embodiments, but are not intended to limit the scope of the invention. The disclosed terms and sentences are intended to be easily explained to the various features of the disclosed invention, but are not intended to limit the scope of the invention.

In describing the present disclosure, the detailed description of related known technologies will be omitted if it is determined that they unnecessarily make the gist of the present disclosure unclear.

Hereinafter, a temperature measurement method using an intensity ratio of a fluorescence signal and a temperature sensor system according to an embodiment of the present disclosure will be described.

The present disclosure is to provide a technical method for solving various problems of the related art, and provides a temperature measurement method using the fluorescence characteristic of an optical material having a temperature-dependent property.

A method using the temperature dependence of the fluorescence intensity according to the related art uses a method of measuring the intensity ratio of a fluorescence signals emitted while electrons in two thermally coupled high energy levels fall to the same low energy level, respectively. Since the relative intensity of the fluorescence signals generated at the thermally coupled energy level follows the

Boltzmann distribution to have temperature dependence. Accordingly, the temperature may be calculated inversely by measuring the intensity ratio of the fluorescence signals using the same. A fluorescence intensity ratio R between two fluorescence signals is given by Equation 1 below.

$$R = \frac{{I}_{2} ( 4 {F}_{\text{?} / 2} - 4 {I}_{\text{?} / 2} )}{{I}_{1} ( 4 {F}_{\text{?} / 2} - 4 {I}_{\text{?} / 2} )} = \frac{{N}_{2}}{{N}_{1}} = \frac{{g}_{2} {ω}_{20} {A}_{20}}{{g}_{1} {ω}_{10} {A}_{20}} exp ( \frac{- Δ \text{?}}{kT} ) \qquad [ Equation 1 ]$$

$$\text{?} \text{indicates text missing or illegible when filed}$$

In Equation 1, Iᵢ represents a fluorescence signal intensity, Nᵢ represents an population of energy state, gᵢ represents a degeneracy, ωᵢ represents an angular frequency, Aᵢ represents a spontaneous emission rate, ΔE represents an energy gap between thermally coupled energy levels (low energy level i=1, high energy level i=2), k represents a Boltzmann constant, and T represents a temperature.

The method using the temperature dependence of the fluorescence intensity has an advantage in that signal analysis is easier than the method using the temperature dependence of a fluorescence lifetime. Since a ratio of two fluorescence signals is used to calculate the temperature, the method has a self-compensation function on optical signal noise to reduce errors caused by the instability of the output of excitation light used to obtain the fluorescence signal and the loss of an optical waveguide.

For the temperature measurement through the dependence of a fluorescence intensity, thermally coupled energy levels of rare earth ions such as Er³⁺, Nd³⁺, Pr³⁺, and Eu³⁺ may be used. Among them, in the case of using Nd³⁺ compared to other rare earth ions, there are advantages of having easy measurement due to high fluorescence efficiency and excellent temperature sensitivity.

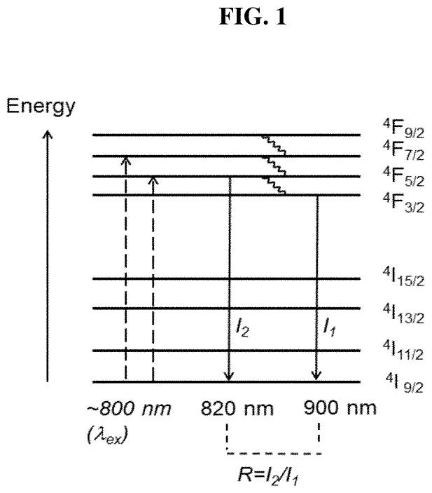

Referring to FIG. 1, a temperature calculation method using an intensity ratio of two fluorescence signals generated in Nd³⁺ according to the related art will be described in more detail. Referring to FIG. 1, Nd³⁺ ions, which are one of rare earth ions, have energy levels, such as 4F_{9/2}, 4F_{7/2}, 4F_{5/2}, 4F_{3/2}, 4I_{5/2}, 4I_{3/2}, 4I_{11/2}, and 4I_{9/2}.

In FIG. 1, when pumping is performed using pump light (laser diode) in a wavelength range (785 to 805 nm) located near 800 nm, electrons at the energy level 4I_{9/2} are excited to 4F_{5/2} or 4F_{7/12}. Subsequently, the electrons excited to 4F_{7/2} and 4F_{5/2} exchange phonon energy according to the thermal state of a material and may fall to energy levels 4F_{5/2} and 4F_{3/2} lower than 4F_{7/2} and 4F_{5/2}. The excited electrons fall to the lower energy level 4I_{9/2} to make two types of fluorescence signals . In the case of a transition of 4F_{5/2}, 4I_{9/2} with a large energy difference, a fluorescence signal near 820 nm (band A) is generated, in the case of a transition of 4F_{3/2}→4I_{9/2} with an energy difference smaller therethan, a fluorescence signal near 900 nm (band B) which is a wavelength longer therethan is generated.

In FIG. 1, the energy levels 4F_{5/2} and 4F_{3/2} are thermally coupled according to the Boltzmann distribution to have temperature dependence. Accordingly, the temperature may be calculated by measuring the intensity ratio of the fluorescence signals in the band A (820 nm) and the band B (900 nm) .

However, in the case of this method, the electron density at the energy level 4F_{5/2} is relatively lower than that at the energy level 4F_{3/2}, and as a result, there is a disadvantage that the fluorescence signal generated in the band A is very weak to generate a lot of noise. Therefore, the accuracy of the temperature signal calculated therefrom also deteriorates.

In addition, in the case of this method, since the wavelength position of the fluorescence signal generated in the band A (820 nm) is very close to the wavelength (785 to 805 nm) of the pump light, there is a problem in that the fluorescence signal is buried in the optical output spectrum of the pump light or greatly affected by noise characteristics caused by an output change of the pump light, etc. Therefore, in order to solve this disadvantage, there is a difficulty to improve the optical characteristics of the pump light by using an expensive laser with a narrow line width as the pump light or using an additional optical component such as an optical filter.

In order to solve this problem, the present disclosure is characterized to use an energy level having a high intensity of the fluorescence signal. In addition, the fluorescence signal is characterized as a fluorescence signal having a wavelength of 60 nm or more away from the wavelength of a pump light to be used for excitation.

In the case of an optical temperature measurement method, a temperature measurement range, stability, and noise characteristics are greatly affected by the optical characteristics of an optical material, a wavelength position used for temperature measurement, an optical interrogation time, and a temperature calculation algorithm using the same. In particular, in the case of the temperature measurement method using the fluorescence characteristic, it is very important to properly select a pump wavelength, a wavelength of a fluorescence signal to be used for measurement, and a method for calculating a temperature therefrom.

The temperature measurement method using the intensity ratio of the fluorescence signal according to the embodiment of the present disclosure uses the intensity ratio of the fluorescence signals generated according to a difference between energy levels of rare earth ions excited by the pump light. The pump light is an energy source that converts electrons present at a low energy level in the rare earth ions to an excited state with a high energy level.

The fluorescence signal may be generated by an energy transition of the rare earth ions from a high energy level to a low energy level, and in this case, the energy transition may be an electron transition from a high energy level to a low energy level in the rare earth ions. The wavelength of the fluorescence signal may be 60 nm or more spaced apart from the wavelength of the pump light, and more specifically, the wavelength of the fluorescence signal may be 60 nm or longer than the wavelength of the pump light. More preferably, the wavelength of the fluorescence signal may be 90 nm or more spaced apart from the wavelength of the pump light, and more specifically, the wavelength of the fluorescence signal may be 90 nm or longer than the wavelength of the pump light.

The intensity ratio of the fluorescence signal is an intensity ratio of a pair of fluorescence signals generated by a difference in different energy levels of the rare earth ions, and the intensity ratio of the pair of fluorescence signals may be an intensity ratio of two fluorescence signals generated according to the difference in different energy levels of the rare earth ions. Each of the wavelengths of the pair of fluorescence signals (two fluorescence signals) may be 60 nm or more spaced apart from the wavelength of the pump light, and preferably, the wavelengths of the pair of fluorescence signals (two fluorescence signals) may be a wavelength of 60 nm or longer than the wavelength of the pump light, respectively. More specifically, the intensity ratio of the pair of fluorescence signals is an intensity ratio of a first fluorescence signal and a second fluorescence signal generated according to a difference in different energy levels of the rare earth ions, and the wavelengths of the first fluorescence signal and the second fluorescence signal may be a wavelength of 60 nm or more spaced apart from the wavelength of the pump light. More preferably, the wavelength of the first fluorescence signal and the wavelength of the second fluorescence signal may be 60 nm or longer than the wavelength of the pump light. As an example, the difference in energy level for generating one fluorescence signal (first fluorescence signal) of the pair of fluorescence signals may be different from a difference in energy level for generating the other fluorescence signal (second fluorescence signal) . In this case, the wavelength of the first fluorescence signal may be a wavelength of 60 nm or more spaced apart from the wavelength of the pump light or a wavelength of 60 nm or longer than the wavelength of the pump light. In addition, the wavelength of the second fluorescence signal may be a wavelength of 60 nm or more spaced apart from the wavelength of the pump light or a wavelength of 60 nm or longer than the wavelength of the pump light . More preferably, the wavelength of the first fluorescence signal may be a wavelength of 90 nm or more spaced apart from the wavelength of the pump light or a wavelength of 90 nm or longer than the wavelength of the pump light. In addition, the wavelength of the second fluorescence signal may be a wavelength of 90 nm or more spaced apart from the wavelength of the pump light or a wavelength of 90 nm or longer than the wavelength of the pump light.

Each of the pair of fluorescence signals may be a fluorescence signal at a wavelength of 60 nm or more spaced apart from the wavelength of the pump light, the pair of fluorescence signals may be generated by an energy transition from one high energy level to two low energy levels, and the two low energy levels may each have different energy levels. More specifically, in the pair of fluorescence signals, the first fluorescence signal may be generated according to a difference in energy level from a first high energy level to a first low energy level, and the second fluorescence signal may be generated according to a difference in energy level from a first high energy level to a second low energy level. In this case, the wavelength of the first fluorescence signal and the wavelength of the second fluorescence signal may be 60 nm or more spaced apart from the wavelength of the pump light. Preferably, the wavelength of the first fluorescence signal and the wavelength of the second fluorescence signal may be a wavelength of 60 nm or longer than the wavelength of the pump light, respectively. More preferably, the wavelength of the first fluorescence signal may be a wavelength of 90 nm or more spaced apart from the wavelength of the pump light or a wavelength of 90 nm or longer than the wavelength of the pump light. In addition, the wavelength of the second fluorescence signal may be a wavelength of 90 nm or more spaced apart from the wavelength of the pump light or a wavelength of 90 nm or longer than the wavelength of the pump light.

Each of the pair of fluorescence signals may be a fluorescence signal at a wavelength of 60 nm or more spaced apart from the wavelength of the pump light, the pair of fluorescence signals may be generated by an energy transition from two different high energy levels to a low energy level (or low energy levels), and the two different high energy levels may be thermally coupled energy levels according to a Boltzmann distribution. In this case, the low energy level may be two different energy levels, and may be the same one energy level. More specifically, in the pair of fluorescence signals, the first fluorescence signal may be generated according to a difference in energy level from a first high energy level to a first low energy level, and the second fluorescence signal maybe generated according to a difference in energy level from a second high energy level to the first energy level or a second low energy level. At this time, the wavelength of the first fluorescence signal and the wavelength of the second fluorescence signal may be 60 nm or more spaced apart from the wavelength of the pump light. Preferably, the wavelength of the first fluorescence signal and the wavelength of the second fluorescence signal may be a wavelength of 60 nm or longer than the wavelength of the pump light, respectively. More preferably, the wavelength of the first fluorescence signal may be a wavelength of 90 nm or more spaced apart from the wavelength of the pump light or a wavelength of 90 nm or longer than the wavelength of the pump light. In addition, the wavelength of the second fluorescence signal may be a wavelength of 90 nm or more spaced apart from the wavelength of the pump light or a wavelength of 90 nm or longer than the wavelength of the pump light .

The rare earth ion may be Nd³⁺. When the rare earth ion is Nd³⁺, the high energy level may be 4F_{3/2} or 4F_{5/2}, preferably 4F_{3/2}. The low energy level may be two energy levels selected from the group consisting of 4I_{9/2}, 4I_{11/2} and 4I_{13/2}, and more specifically, the combination of the two low energy levels may be 4I_{9/2} and 4I_{11/2}; 4I_{11/2} and 4I_{13/2}; or 4I_{9/2} and 4I_{13/2}.

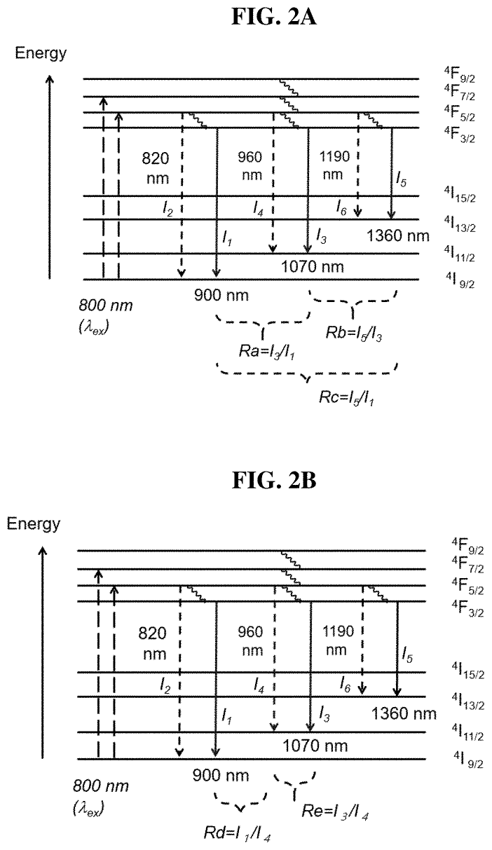

A temperature calculation method using an intensity ratio R of two fluorescence signals generated in Nd³⁺ will be described in more detail with reference to FIGS. 2A and 2B.

As a first embodiment or a second embodiment, the pair of fluorescence signals may be generated by an energy transition from one high energy level to two low energy levels.

Referring to FIG. 2A and Equation 2, as a first embodiment, the temperature may be calculated by using an intensity ratio Rₐ of a fluorescence signal (first fluorescence signal) generated by an energy transition of 4F_{3/2}→4I_{9/2} and a fluorescence signal (second fluorescence signal) generated by an energy transition of 4F_{3/2}→4I_{9/2} of a fluorescence material containing Nd³⁺. In the case of the energy transition of 4F_{3/2}→4I_{9/2}, a fluorescence signal I₁ (first fluorescence signal) in a 900 nm band is generated, and in the case of the energy transition of 4F_{3/2}→4I_{11/2}, a fluorescence signal I₃ (second fluorescence signal) in a 1070 nm band is generated. Each energy transition is affected by a thermally coupled energy level, and as a result, when an energy transition occurs from one same high energy level 4F_{3/2} to two different low energy levels, a relative energy transition probability has a temperature-dependent characteristic. Accordingly, as a result, the temperature may be calculated using these characteristics.

$${R}_{a} = \frac{{I}_{3} ( 4 ( {F}_{3 / 2} - 4 {I}_{11 / 2} )}{{I}_{1} ( 4 {F}_{3 / 2} - 4 {I}_{9 / 2} )} , \\ {R}_{b} = \frac{{I}_{\text{?}} ( 4 {F}_{3 / 2} - 4 {I}_{13 / 2} )}{{I}_{3} ( 4 {F}_{3 / 2} - 4 {I}_{11 / 2} )} , \\ {R}_{c} = \frac{{I}_{\text{?}} ( 4 {F}_{3 / 2} - 4 {I}_{13 / 2} )}{{I}_{1} ( 4 {F}_{3 / 2} - 4 {I}_{9 / 2} )} \qquad [ Equation 2 ]$$

$$\text{?} \text{indicates text missing or illegible when filed}$$

In the existing method, a technique using a transition between two energy levels having different high energy levels from each other and the same low energy levels is used. On the other hand, in the present disclosure, a method using a transition between two energy levels having the same high energy level and different low energy levels from each other has an energy transition structure distinguished from the existing method.

In addition, in the case of this method (the first embodiment), there is an advantage that both the fluorescence signals generated in the 900 nm band and the 1070 nm band may secure a signal intensity that is 8 dB or more higher than that of the fluorescence signal generated in a 820 nm band, thereby increasing the measurement accuracy. Accordingly, it is possible to reduce the system cost by using a relatively low-power laser diode device for the pump. In addition, a single laser diode using a branching element may be used as a light source for a plurality of sensor probes.

In addition, in the case of the method (the first embodiment) according to the present disclosure, there is an advantage that since the wavelength band of the fluorescence signal used for temperature calculation is 60 nm or more spaced apart from the wavelength of the pump light and thus not affected by an output spectrum of the pump light.

Preferably, in order not to disturb the fluorescence signal by the pump light, it is desirable that the wavelength band of the fluorescence signal used for temperature calculation is 60 nm or more spaced apart from the wavelength of the pump light. More preferably, in order to calculate the accurate temperature without disturbing the fluorescence signal by the pump light, it is preferable that the wavelength band of the fluorescence signal used for temperature calculation is 90 nm or more spaced away from the wavelength of the pump light.

Referring to FIG. 2A, as a second embodiment, an intensity ratio R_{b} of a fluorescence signal (first fluorescence signal) generated by an energy transition of 4F_{3/2}→4I_{11/2} and a fluorescence signal (second fluorescence signal) generated by an energy transition of 4F_{3/2}→4I_{13/2} of a fluorescence material containing Nd³⁺ may be used. In the case of the energy transition of 4F_{3/2}→I_{11/2}, a fluorescence signal I₃ (first fluorescence signal) in a 1070 nm band is generated, and in the case of the energy transition of 4F_{3/2}→4I_{3/2}, a fluorescence signal I₅ (second fluorescence signal) in a 1360 nm band is generated. A relative energy transition probability between these energy levels has a temperature-dependent characteristic. Accordingly, as a result, the temperature may be calculated using these characteristics. In the case of the 1360 nm band, there is an advantage that since the bandwidth is three times or more, it is possible to detect a fluorescence intensity higher than 820 nm. Therefore, it is possible to calculate the temperature using the fluorescence signal intensity ratio R_{b} (see FIG. 2A).

In addition, a fluorescence signal intensity ratio R_{c} between the fluorescence signals I₁ and I₅ generated in the energy transitions of 4F_{3/2}→4I_{9/2} and 4F_{3/2}→4I_{3/2} of the fluorescence material containing Nd³⁺ may be used (see FIG. 2A) .

As a third embodiment, the pair of fluorescence signals may be generated by the energy transition from two different high energy levels to a low energy level (or low energy levels) . Accordingly, the temperature measurement method using the intensity ratio of the fluorescence signals according to an embodiment of the present disclosure may use an intensity ratio between a fluorescence signal by the energy transition of 4F_{5/2}→4I_{11/2} of Nd³⁺ ions as a first fluorescence signal and a fluorescence signal by the other energy transition as a second fluorescence signal.

The second fluorescence signal may be a fluorescence signal generated by an energy transition of 4F_{3/2}→4I_{9/2} or 4F_{3/2}→4I_{11/2} of Nd³⁺ ions . More specifically, in the third embodiment, in the case of two energy levels having the different low energy levels, the second fluorescence signal may be a fluorescence signal generated by the energy transition of 4F_{3/2}→4I_{9/2} of Nd³⁺ ions. Alternatively, in the third embodiment, in the case of one energy level having the same low energy level, the second fluorescence signal may be a fluorescence signal generated by the energy transition of 4F_{3/2}→4I_{11/2} of Nd³⁺ ions .

Referring to FIG. 2B, as a third embodiment, a fluorescence signal I₄ (first fluorescence signal) generated from an energy transition of 4F_{5/2}→4I_{11/2} of a fluorescence material containing Nd³⁺ may be used. In the case of the fluorescence signal I₄ located near 960 nm, since the fluorescence signal I₄ is very far from the wavelength of the pump light, there is an advantage that the fluorescence signal I₄ is not affected by noise and the like generated by the pump light. Accordingly, the temperature may be accurately calculated by using a fluorescence signal intensity ratio R_{d} or Rₑ between the fluorescence signal I₄ and the fluorescence signal I₁ (second fluorescence signal) generated in the energy transition of 4F_{3/2}→4I_{9/2} or the fluorescence signal I₃ (second fluorescence signal) generated in the energy transition of 4F_{3/2}→4I_{11/2} (see FIG. 2B). Since the energy levels 4F_{5/2} and 4F_{3/2} are thermally coupled, the energy levels have a temperature dependence. At the same time, since the wavelengths of the fluorescence signals I₄, I₁, and I₃ generated by the energy transition according to the present embodiment are all 60 nm or more spaced apart from the wavelength of the pump light, there is an advantage that the wavelengths do not interfere with each other to calculate the temperature stably.

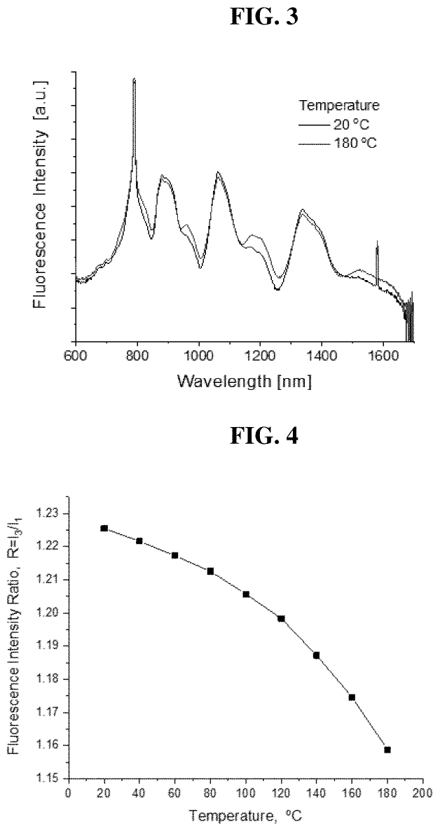

FIG. 3 illustrates a fluorescence spectrum of oxide-based optical glass containing 0.5 mol % of Nd³⁺ ions as a fourth embodiment. The wavelength of the pump light used to generate a fluorescence signal by excitation of the ions is 795 nm. As illustrated in FIG. 3, by the energy transitions of 4F_{3/2}, 4I_{9/2}, 4F_{3/2}→4I_{11/2}, 4F_{3/2}→4I_{13/2}, 4F_{5/2}→4I_{11/2} and 4F_{5/2}→4I_{3/2} (see FIGS. 2A and 2B), it can be seen that strong fluorescence bands are formed in the wavelength bands of 900 nm, 1070 nm, 1360 nm, 960 nm, and 1190 nm, respectively.

FIG. 4 illustrates temperature dependence of a fluorescence intensity ratio (R=I₃/I₁) of a fluorescence signal I₁ at 900 nm (4F_{3/2}→4I_{9/2}) and a fluorescence signal I₃ at 1070 nm (4F_{3/2}→4I_{11/2}) as two emission wavelengths of oxide-based optical glass containing Nd³⁺ ions according to a fourth embodiment. As can be seen from the result, it can be seen that the magnitude of the fluorescence intensity ratio continuously decreases as the temperature increases. Therefore, according to the present disclosure, it is possible to calculate the temperature applied to the sensor probe by measuring the fluorescence signal intensity ratio from the fluorescence signals at the two wavelengths generated by the optical material installed to the temperature sensor probe.

An intensity graph of the fluorescence signal may be fitted to any one or more functions of a polynomial function, an exponential function, and a logarithmic function.

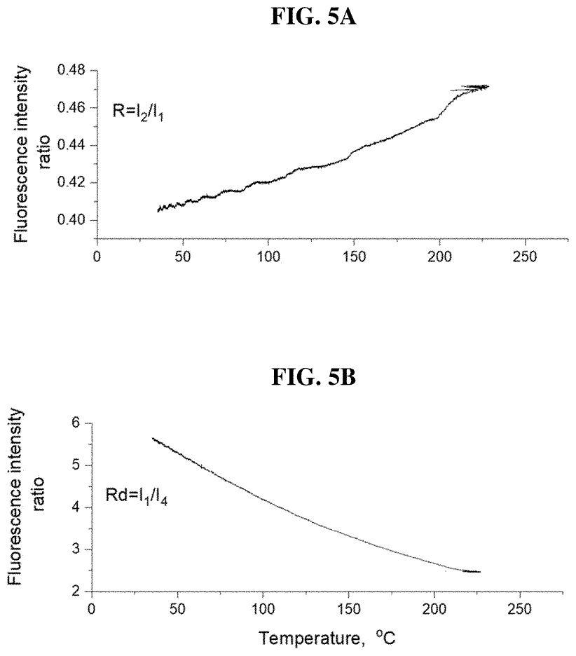

FIG. 5A and FIG. 5B illustrate comparing a temperature calculation characteristic result using a fluorescence intensity ratio analysis method according to the related art with a temperature calculation characteristic result using a fluorescence intensity ratio analysis method according to an embodiment of the present disclosure.

FIG. 5A illustrates a temperature calculation characteristic of a fluorescence intensity ratio (R=I_{2/}I₁, see FIG. 1) at 820 nm by an energy transition of 4F_{5/2}→4I_{9/2} and 900 nm by an energy transition of 4F_{3/2}→4I_{9/2} according to the related art. As illustrated in FIG. 5A, in the case of the related art, it can be seen that as the temperature changes, a change in the fluorescence intensity ratio is very unstable, and a lot of noise is also generated. This is because a difference between the wavelength of the fluorescence signal of 820 nm by the energy transition of 4F_{5/2}→4I_{9/2} and the wavelength (795 nm) of the pump light is very close as about 25 nm, so that apart of a side lobe emission spectrum generated in the vicinity of an operating wavelength of the pump laser diode is distributed to near 820 nm, thereby disturbing the fluorescence signal by Nd³⁺ ions. Accordingly, in this case, when the laser diode becomes unstable due to a surrounding environment, severe noise may occur due to the fluctuation of the side lobe emission spectrum of the laser diode itself.

On the other hand, FIG. 5B illustrates a temperature calculation characteristic of a fluorescence intensity ratio (R_{d}=I₁/I₄, see FIG. 2B) at 900 nm by an energy transition of 4F_{3/2}4I_{9/2} and 960 nm by an energy transition of 4F_{5/2}→4I_{11/2} according to the present disclosure. Since two energy transition wavelengths (the wavelengths of two fluorescence signals) used for temperature calculation are all 60 nm or more spaced apart from the wavelength (795 nm) of the pump light, the energy transition wavelengths are not disturbed by the laser diode for the pump. As illustrated in FIG. 5B, in the case of the temperature calculation characteristic according to the present disclosure, it can be confirmed that as the temperature is changed, a change in the fluorescence intensity ratio is very stable and monotonically variable, and the noise is also very small. Accordingly, the present disclosure has an advantage of measuring the temperature very accurately and stably by using these characteristics.

Further, a temperature sensor system 10 to which the temperature measurement method using the intensity ratio of the fluorescence signals according to the embodiment of the present disclosure is applied uses an intensity ratio of a fluorescence signal generated according to an energy level difference of rare earth ions.

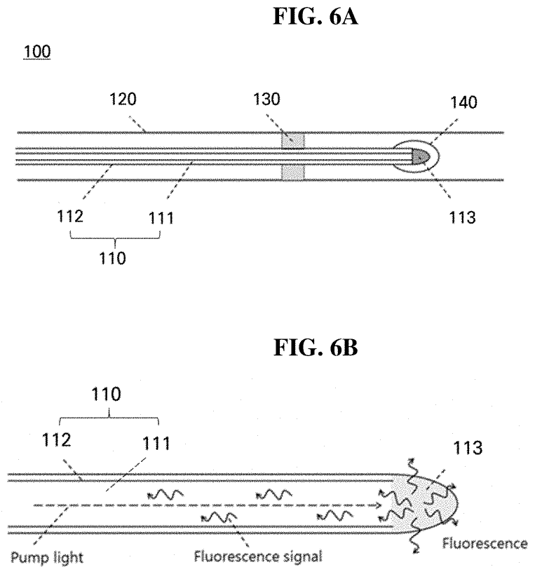

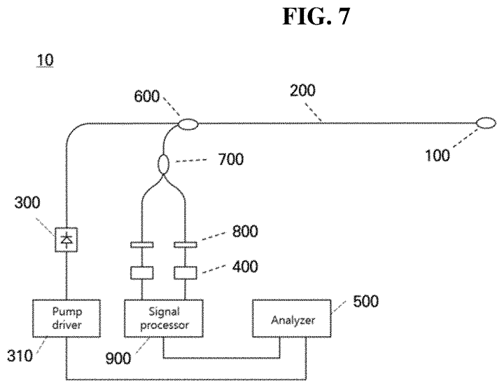

Referring to FIGS. 6A, 6B, and 7, the temperature sensor system 10 may include a temperature sensor probe 100 provided with an optical material 113 containing rare earth ions at one end; and a fiber-optic light guide 200 coupled to the other end of the temperature sensor probe 100. The temperature sensor system 10 may further include a pump source 300 for forming a light source by exciting the rare earth ions through the fiber-optic light guide 200; a photo detector 400 for measuring a fluorescence signal generated from the optical material 113 through the fiber-optic light guide 200; and an analyzer 500 for analyzing the fluorescence signal received through the photo detector 400.

The rare earth ions may be Nd³⁺ ions.

FIG. 6A and FIG. 6B illustrate an overall structure (FIG. 6A) of a temperature sensor probe equipped on a temperature sensor system to which the temperature measurement method using the fluorescence intensity ratio according to the embodiment of the present disclosure is applied and a process (FIG. 6B) of generating and transmitting a fluorescence signal from an end of the temperature sensor probe.

As can be seen in FIG. 6A and FIG. 6B, the temperature sensor probe 100 has a sensor probe tip structure provided with the optical material 113 containing Nd³⁺ ions at one end of an optical fiber 110 having a structure of a core 111 with a high refractive index and a clad 112. Pump light output from the pump light source 300 is incident on the optical material 113 through the core 111 of the optical fiber 110 to excite the rare earth ions (Nd³⁺ ions) contained in the optical material 113. A part of the fluorescence signal generated by the excitation is coupled to the optical fiber 110 and directed in an opposite direction of the pump light, and finally transmitted to the photo detector 400 for temperature calculation. The optical fiber 110 in the temperature sensor probe 100 may be protected from external pressure or contamination by using a protection jacket 120. An adhesive material 130 maybe used to fix between the optical fiber 110 and the protection jacket 120. In addition, as illustrated in FIG. 6B, a protection coating layer 140 may be used to protect one end of the optical fiber 110 provided with the optical material 113.

FIG. 7 illustrates a structure of the temperature sensor system. 10 to which the temperature measurement method using the fluorescence intensity ratio according to the embodiment of the present disclosure is applied. The pump light emitted from the pump light source 300 is transmitted to the temperature sensor probe 100 by passing through the optical fiber guide 200 used for the light guide through a first optical branching element 600 and finally incident to the optical material 113 containing rare earth ions. The pump light source 300 may use a laser diode, an LED device, etc. having a predetermined optical characteristic so as to be necessary for the excitation of rare earth ions, and is operated using a pump driver 310. The fluorescence signal generated from the rare earth ions is transmitted to a second optical branching element 700 through the optical fiber guide 200 used for the temperature sensor probe and the first optical branching element 600. The first optical branching element 600 may use an optical branching element having a wavelength division function, such as a wavelength division multiplexing (WDM) optical coupler, in order to efficiently transmit a fluorescence signal generated from rare earth ions to the second optical branching element 700 side.

The second optical branching element 700 is configured as an optical branching element having a function of dividing and transmitting the fluorescent signal generated from the optical material 113 into two photo detectors 400, and an optical fiber coupler having a predetermined optical coupling ratio may be used. An optical filter 800 is provided between the second optical branching element 700 and the photo detector 400 to transmit only a fluorescence signal of a specific wavelength band. Accordingly, by simultaneously detecting two fluorescent signals using two pairs of optical filters and photo detectors, the temperature applied to the optical material is calculated by analyzing the fluorescent signals through a signal processor 900 and the signal analyzer 500.

The above description is just illustrative of the technical idea of the present disclosure, and various changes and modifications can be made within the scope without departing from the essential characteristics of the present disclosure.

Various embodiments disclosed herein may be performed regardless of the order, and may be performed simultaneously or separately.

In an embodiment, at least one step may be omitted or added in each of the drawings described herein, and may be performed in reverse order, and may be performed simultaneously.

Therefore, the embodiments of the present disclosure are provided for illustrative purposes only but not intended to limit the technical concept of the present disclosure. The scope of the technical concept of the present disclosure is not limited thereto.

The protective scope of the present disclosure should be construed based on the following claims, and all the techniques in the equivalent scope thereof should be construed as falling within the scope of the present disclosure.

What is claimed is:

1. A temperature measurement method using an intensity ratio of fluorescence signals by using an intensity ratio of fluorescence signals generated according to an energy level difference of rare earth ions excited by pump light.

2. The temperature measurement method using the intensity ratio of the fluorescence signals of claim 1, wherein the intensity ratio of the fluorescence signals is an intensity ratio of a pair of fluorescence signals generated according to a difference between different energy levels of rare earth ions.

3. The temperature measurement method using the intensity ratio of the fluorescence signals of claim 2, wherein the wavelengths of the fluorescence signals are 60 nm or more spaced apart from the wavelength of the pump light.

4. The temperature measurement method using the intensity ratio of the fluorescence signals of claim 3, wherein the pair of fluorescence signals are generated by an energy transition from one high energy level to two low energy levels .

5. The temperature measurement method using the intensity ratio of the fluorescence signals of claim 4, wherein the rare earth ions are Nd³⁺ ions.

6. The temperature measurement method using the intensity ratio of the fluorescence signals of claim 5, wherein the high energy level is 4F_{3/2}, and
the low energy levels are two energy levels selected from the group consisting of 4I_{9/2}, →4I_{11/2}, and 4I_{3/2}.

7. The temperature measurement method using the intensity ratio of the fluorescence signals of claim 3, wherein the pair of fluorescence signals are generated by an energy transition from two different high energy levels from each other to a low energy level or low energy levels.

8. The temperature measurement method using the intensity ratio of the fluorescence signals of claim 7, wherein the intensity ratio of the fluorescence signals is an intensity ratio between a first fluorescence signal by an energy transition of 4F_{5/2}→4I_{11/2} of Nd³⁺ ions and a second fluorescence signal generated by the other energy transition.

9. The temperature measurement method using the intensity ratio of the fluorescence signals of claim 8, wherein the second fluorescence signal is a fluorescence signal generated by an energy transition of 4F_{3/2}→4I_{9/2} or 4F_{3/2}→4I_{11/2} of Nd³⁺ ions .

10. The temperature measurement method using the intensity ratio of the fluorescence signals of claim 1, wherein the intensity ratio graph of the fluorescence signals is fitted to any one or more functions of a polynomial function, an exponential function, and a logarithmic function.

11. A temperature sensor system using an intensity ratio of a fluorescence signal generated according to an energy level difference of rare earth ions.

12. The temperature sensor system of claim 11, comprising:
a temperature sensor probe provided with an optical material containing rare earth ions at one end; and
an optical fiber guide coupled to the other end of the temperature sensor probe.

13. The temperature sensor system of claim 12, further comprising:
a pump light source for forming a light source exciting the rare earth ions through the light fiber guide;
a photo detector for measuring a fluorescence signal generated from the optical material through the light fiber guide; and
an analyzer for analyzing the fluorescence signal received through the photo detector.
